(19) United States
(12) Patent Application Publication
(10) Pub. No.: US 2001/0033480 A1
(43) Pub. Date: Oct. 25, 2001

(54) LCD illuminating device

(75) Inventors: Tsutomu Wakabayashi, Yokohama-shi (JP); Akihiro Sugiyama, Kawasaki-shi (JP); Shinichi Tsukada, Toride-shi (JP)

Correspondence Address: OLIFF & BERRIDGE, PLC, 277 S. WASHINGTON STREET, SUITE 500, ALEXANDRIA, VA, 22314, US

(73) Assignee: NIKON CORPORATION

(21) Appl. No.: 09/832,204

(22) Filed: Apr. 11, 2001

(30) Foreign Application Priority Data
Apr. 12, 2000 (JP) 2000-110444
Apr. 20, 2000 (JP) 2000-119060

(51) Int. Cl. F21V 8/00

(52) U.S. Cl. 362/31; 362/561

(57) ABSTRACT

An LCD illuminating device is equipped with a light guide device for guiding light from LEDs for illumination to a display panel, and illuminates segments on the display panel when a subject image is dark. The light guide device comprises a light guide with reflecting surfaces of which are parabolic in shape. The LEDs are located substantially at focal points of the parabolic reflecting surfaces so that the segment in a diffusing state on the display panel can be illuminated in a bright and uniform manner.

### INCORPORATION BY REFERENCE

The disclosures of the following priority applications are herein incorporated by reference:

Japanese Patent Application No.2000-110444 filed Apr. 12, 2000

Japanese Patent Application No.2000-119060 filed Apr. 20, 2000

### BACKGROUND OF THE INVENTION

1. Field of the Invention

The present invention relates to an LCD illuminating device for lighting up a transparent liquid crystal panel capable of displaying required information in a superimposed manner on an optical image, and is particularly applicable to uses in superimposed displaying etc. in camera finder apparatus.

2. Description of the Related Art

Liquid crystal panels are transparent display devices capable of displaying required information in a superimposed manner on an optical image. For example, liquid crystal panels employing Polymer Dispersed Liquid Crystal (PDLC) can be employed in camera finder device. This liquid crystal panel comprises PDLC layer that is enclosed between two transparent substrates with transparent electrodes, with a plurality of display segments. This liquid crystal panel controls an electric field applied to PDLC layer so as to display making appropriate use of two modes, namely a transparent state where light is allowed to pass, and a diffusing state where light is diffused.

When this liquid crystal panel is driven, display segments to which an electric field is applied allow light to pass, and display segments to which no electric field is applied cause light to be diffused (scattered). When a subject image is bright, the display segments in a diffusing state appear to be dark. On the other hand, when the subject image is dark, the display segments in a diffusing state can be made to appear bright by illuminating the liquid crystal layer (related art 1).

On the other hand, a structure for a finder device for positioning a guest host LCD plate between a pentaprism and a focusing glass is disclosed in Japanese Laid-open Patent Publication No. H 4-345150 (related art 2). This finder device is equipped with a first support for holding a display body that displays on the finder image in a superimposed manner, and a second support, coupling with the first support, for holding the pentaprism. The display body is supported between the first support and the second support.

However, when a plurality of LEDs are employed as light sources for illuminating the liquid crystal layer of related art 1, there is a luminance difference of a number of times between the brightest LEDs and the darkest LEDs due to non-uniformity of the luminance of the LEDs. Therefore, the irregularities of the brightness occur on the liquid crystal panel, i.e. on the finder.

However, when just one LED is employed in order to prevent the irregularities of the brightness, the brightness is insufficient, which means that display segments are not sufficiently bright and in some cases may not be visible at all.

Further, utilization of the structure of related art 2 for allocating a device for illuminating the PDLC display panel causes the illuminating device to be protruded from the first support. The first support is normally supported at the front body of the camera and this causes the illuminating device to interfere with the front body of the camera and complicates assembly. Building-in the illuminating device after the first support is incorporated into the front body of the camera has been considered, but this is undesirable from an assembly point of view as this means that the illuminating device will no longer be integral with the finder unit.

### SUMMARY OF THE INVENTION

A first object of the present invention is to provide an LCD illuminating device capable of illuminating a selected display segment on a display panel in a uniform manner.

A second object of the present invention is to provide an LCD illuminating device being small and capable of being integrated with a finder unit.

In order to achieve the first object, in the present invention, an LCD illuminating device comprises a display panel enclosing liquid crystal layer capable of switching between a diffusing state where light is diffused and a transparent state where light is transmitted with a plurality of display segments, a selection unit that selects at least one display segment of the plurality of display segments of the display panel, a drive circuit that drives a display segment selected by the selection unit into the diffusing state and unselected display segments into the transparent state, a light source having a light emitting section that generates light for illuminating the display panel and a light guide device having at least one light guide member that guides light from the light source to the display panel. And the light guide member has a reflecting surface formed at least partially in a parabolic shape, and the light emitting section of the light source is located substantially at a focal point of the parabolic reflecting surfaces.

The display panel may be provided with two transparent substrates, the liquid crystal layer is enclosed between the transparent substrates, and electrodes electrically connecting with the display segments are provided on at least one of the transparent substrates. The thickness of the light guide member is preferably substantially the same as the thickness of the display panel. The thickness of the light guide member may also be substantially the same as the sum of the thicknesses of two transparent substrates. The thickness of the light guide member may also be substantially the same as the thickness of one of the transparent substrates.

At least two light guide members may be provided, with the thickness of one of the light guide members being substantially the same as the thickness of one of the transparent substrates and the thickness of the remainder being substantially the same as the sum of the thicknesses of the two transparent substrates. The light guide member may preferably be located at one of the transparent substrates side having the electrodes.

In order to achieve the second embodiment, in the present invention, an LCD illuminating device comprises a display panel enclosing liquid crystal layer capable of switching between a diffusing state where light is diffused and a transparent state where light is transmitted with a plurality of display segments, a selection unit capable of selecting at least one display segment of the plurality of display segments of the display panel, a drive circuit that drives a display segment selected by the selection unit into the diffusing state and unselected display segments into the transparent state, a light source for generating light for lighting up the display panel from a light emitting section and a light guide device, having at least one light guide member for guiding light from the light source, for guiding light from the light source to the display panel, wherein the light guide member is constituted by, a light guide section for guiding light of the light source in a direction orthogonal to the display surface of the display panel, an emitting section for emitting light to an irradiated part of the display panel and a reflecting section for reflecting light guided by the light guiding section to the emitting section.

The light guide member has preferably side surfaces formed in parabolic shape along the light propagating in the light guiding section.

Dimensions of the light guide member is preferably such that the thickness of the emitting section is substantially the same as the display panel. The display panel can be provided with electrodes at an end portion of the display panel thereof, and the substantial range of emission of light from the emitting section of the light guide member is restricted by a conducting member connecting the electrodes of the display panel and a circuit substrate.

The display panel includes a transparent substrate parallel to an optical axis of a lens for optically forming an image, and light emitted from the emitting section of the light guide member may be incident onto the irradiated part which is located at an end surface of the transparent substrate. The light guide member may also be located in the vicinity of the end surface of the transparent substrate.

The LCD illuminating device of the present invention may also have shaded sections formed at end surfaces of the display panel where light is not incident. Further, it is preferable to insert at least one polarizing plate between the display panel and the light guide member.

### BRIEF DESCRIPTION OF THE DRAWINGS

FIG. 1 is a view giving a conceptual illustration of a structure for a single-lens reflex camera incorporating the LCD illuminating device of embodiments of the present invention.

FIG. 2 is a plan view showing the details of a light guide device for the LCD illuminating device of the first embodiment of the present invention.

FIG. 3 is a cross-sectional view cut through substantially the center of the display panel of FIG. 2 along a straight line parallel to an end surface 10b of the display panel 10.

FIG. 4 is a view showing a selector 50 of the LCD illuminating device of the embodiments of the present invention.

FIG. 5 is a view showing a state where a central segment 101 is selected by a focus area selector 501 shown in FIG. 4.

FIG. 6 is a flowchart showing the operation (main routine) of a CPU 8 of the LCD illuminating device of the embodiments of the present invention.

FIG. 7 is a flowchart showing the operation (selected area determination subroutine) of a CPU 8 of the LCD illuminating device of the embodiments of the present invention.

FIG. 8 is a perspective view showing a single-lens reflex camera of a second embodiment.

FIG. 9 is a perspective view of a pentaprism of a single-lens reflex camera of the second embodiment cut substantially centrally along a plane orthogonal to an optical axis.

FIG. 10 is a perspective view showing a light guide device 40, of the second embodiment, for guiding light from the light source 30 of FIG. 1 to the end surface 10a of a display panel 10 and a support structure for this light guide device 40.

FIG. 11 is a cross-sectional view cut through substantially the center of a pentaprism 5 of the second embodiment along a plane orthogonal to an optical axis.

FIG. 12 is an enlarged view of the periphery of a light guide 403 of FIG. 11.

FIG. 13 is an enlarged view of the periphery of a light guide 404 of FIG. 11.

FIG. 14 is a perspective view, from the side of the display panel 10, showing a light guide 403 of the second embodiment.

FIG. 15 is a perspective view, from the side of the display panel 10, showing a light guide 404 of the second embodiment.

### DESCRIPTION OF THE PREFERRED EMBODIMENTS

### First Embodiment

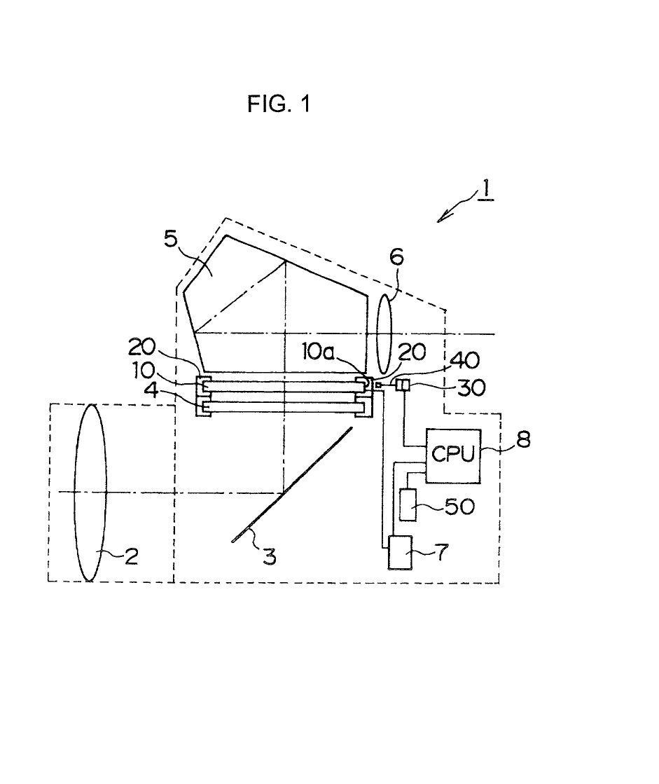

FIG. 1 is a view illustrating a structure for a single-lens reflex camera incorporating the LCD illuminating device of the embodiments of the present invention.

As shown in FIG. 1, a camera 1 comprises a photographing lens 2 for forming an image of a subject on a film, a flip-up method reflecting mirror 3 for changing the path of light coming from the photographing lens 2, a screen 4 located at a conjugate surface at a film with respect to the photographing lens 2, a PDLC display panel 10 located in the vicinity of the screen 4, a pentaprism 5 which bends light passing through the screen 4 and the display panel 10 so as to observe light, an eyepiece 6 for monitoring an image projected on the screen 4 and the like. The display panel 10 is supported by the holder 20 so as to be fixed to the camera.

In addition to the display panel 10, the display device of the camera 1 is also constituted by a light source 30 comprising LEDs etc., a light guide device 40 for guiding light from the light source 30 to end surfaces 10a of the display panel 10, a drive circuit 7 for driving the display panel 10, a CPU 8, a selector 50 (a selection unit) for selecting segments of the display panel 10, and the like.

The CPU 8 is a central processing unit for exerting unified control on the operation of the camera 1 based on signals from an AE device or an AF device etc. (not shown in the figures). Further, the CPU 8 controls display states of the display panel 10 via a drive circuit 7 based on a signal from a selector 50.

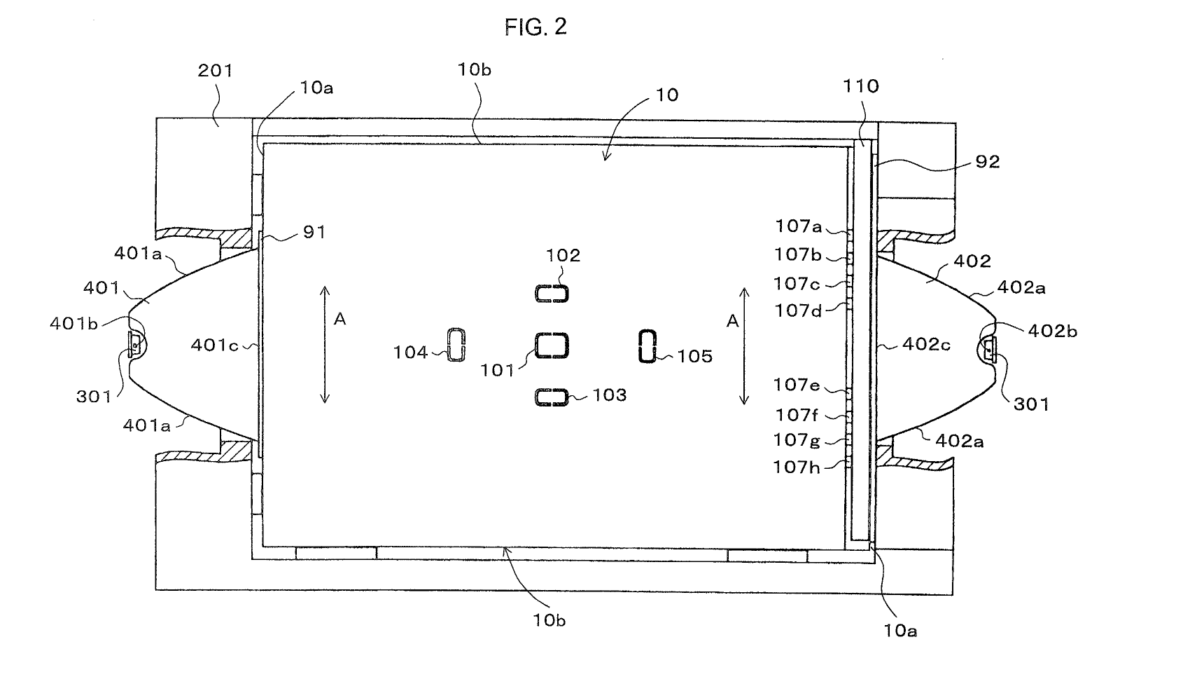

The display panel 10 is equipped with five segments 101 to 105, as shown, for example, in FIG. 2. One of the segments 101 to 105 can then be selected by the selector 50. Further, the background (background region), other than the segments 101 to 105, occupying a large part of the surface area of the display panel 10, and which allows an image projected on the screen 4 to pass as it is, is also a kind of segment, and is normally driven so as to be transparent.

The display panel 10 is driven by the drive circuit 7. When a signal for updating driving is received from the CPU 8, the drive circuit 7 updates, depending on the state of the display panel 10, in such a manner as to perform switching so that segments in a diffusing state are put into a transparent state and segments in a transparent state are put into a diffusing state.

The drive circuit 7 is constructed in such a manner that the central segment 101 is put into a diffusing state when a battery is first put into the camera.

A description is now given of a light guide device 40 for guiding light from the light source 30 to end surfaces 10a of the display panel 10.

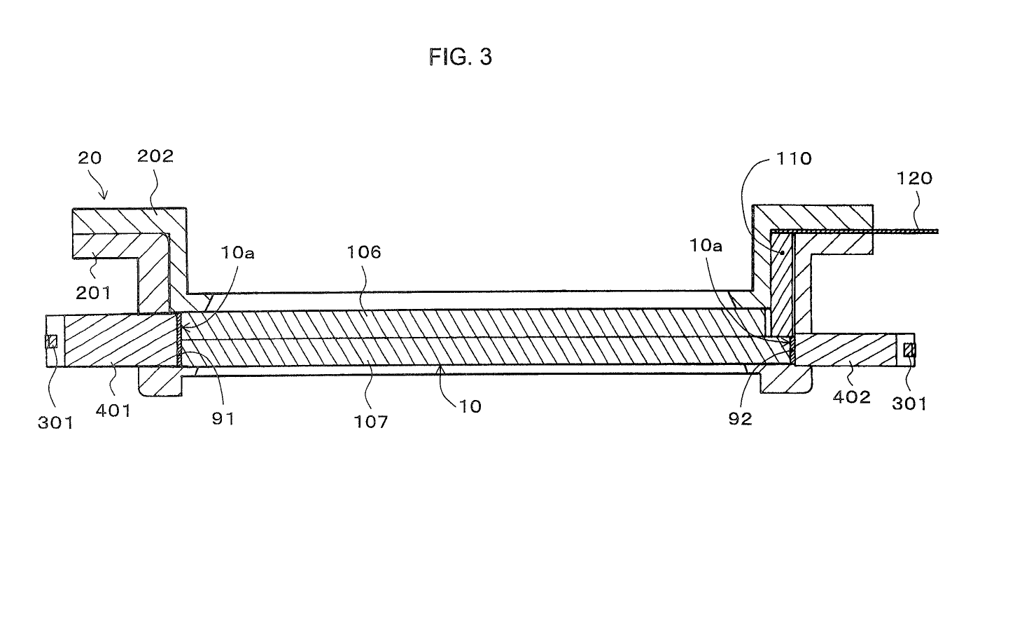

FIG. 2 and FIG. 3 are views showing the details of a light guide device 40 for the LCD illuminating device of the first embodiment of the present invention. FIG. 2 is a plan view, and FIG. 3 is a cross-sectional view cut through substantially the center of the display panel 10 of FIG. 2 along a straight line parallel to an end surface 10b. Members that are the same as in FIG. 1 are given the same numerals.

As shown in FIG. 3, the holder 20 comprises two members, a lower holder 201 and an upper holder 202, and provides support by sandwiching the display panel 10. The upper holder 202 is omitted in FIG. 2 for ease of viewing.

The display panel 10 comprises an upper glass (transparent substrate) 106 and a lower glass (transparent substrate) 107, with liquid crystal enclosed between the upper glass 106 and the lower glasses 107.

The light guide device 40 is equipped with two light guides (light guide members) 401 and 402. The light guides 401 and 402 consist of resin plates of transparent polycarbonate or acrylic resin etc. with the end surfaces 401a and 402a formed in the shape of parabolic surfaces (FIG. 2). As shown in FIG. 3, the thickness of the light guide 401 is substantially the same as the thickness of the display panel 10, and the thickness of the light guide 402 is substantially the same as the lower glass 107 of the display panel 10. Conditions for these thicknesses are described in the following.

As described in the following, electrodes 107a, 107b, 107c, 107d, 107e, 107f, 107g, 107h (FIG. 2) located on the lower glass 107 and a flexible printed board 120 (FIG. 3) can be connected using zebra gum 110. It is therefore necessary to cut off a portion of the upper glass 106 where the zebra gum 110 is located.

The light source 30 comprises two LEDs 301 and a circuit for driving the LEDs (not shown in the figures). The two LEDs 301 are located so as to have light emitting sections at each of the focal points 401b and 402b (FIG. 2) of the light guides 401 and 402. This arrangement for the light emitting sections is to ensure that the display panel 10 is illuminated uniformly, as described hereinafter.

Based on the theory of the parabolic mirror, light from the LEDs is output as parallel rays perpendicular to the end surfaces 401c and 402c because the end surfaces 401a and 402a of the light guides 401 and 402 are parabolic surfaces. This means that light outputted from the end surfaces 401c and 402c is uniform and bright. The width of the end surfaces 401c and 402c encompasses the range within which the segments 101 to 105 are located, as shown in FIG. 2.

With this structure for the light source 30, bright and uniform light can be emitted from the end surfaces 401c and 402c of the light guides 401 and 402 by just providing a single LED 301 for each of the light guides 401 and 402. Therefore, any of the segments 101 to 105 can be illuminated uniformly and brightly.

The amount of LED light incident onto the display panel 10 is influenced by the dimensions of portions within the light guides 401 and 402 within which the LED light is incident. As described above, the thickness of the light guide 402 is approximately half the thickness of the light guide 401. There is therefore more LED light incident to the display panel 10 from the light guide 401 than LED light incident from the light guide 402.

However, with the LCD illuminating device of the embodiment of the present invention, the end surfaces 401a and 402a constituting the reflecting surfaces of the light guides 401 and 402 are parabolic in shape. Therefore, according to the theory of the parabolic mirror, light emitted from the end surfaces 401c and 402c of the light guides 401 and 402 can travel far. The slight difference in the amount of light due to the differences in thickness of the light guides 401 and 402 therefore has little influence on the illumination of the segments 101 to 105.

For the same reason, there is almost no influence on the brightness with which the segments 101 to 105 are illuminated even if the luminance difference of the two LEDs 301 is a multiple of times.

When LED light incident to the display panel 10 passes through the transparent sections of the liquid crystal layer, some slight scattering still occurs. This causes the transparent sections of the display panel 10 to gleam when the subject image is dark.

As shown in FIG. 2 and FIG. 3, polarizing plates 91 and 92 are inserted between the end surfaces 10a of the display panel 10 and the light guides 401 and 402 so that it is difficult for LED light to go out in a direction perpendicular to the paper surface of FIG. 2, i.e. the light is polarized in the direction of the arrow A of FIG. 2. This dramatically reduces the phenomena of the transparent sections of the display panel 10 gleaming.

The amount of light for the two LEDs 301 is reduced, as a result of introducing the polarizing plates 91 and 92. However, as described above, this reduction in the amount of light due to the introduction of the polarizing plates 91 and 92 has no influence upon the brightness because the end surfaces 401a and 402a of the light guides 401 and 402 are parabolic surfaces so that the amount of light of the LEDs 301 is used in an effective manner.

When the difference in thicknesses of the light guides 401 and 402 influences the brightness with which the segments 101 to 105 are illuminated, the polarizing plate 92 introduced between the thinner light guide 402 and the display panel 10 may be removed. Therefore, the amount of LED light outputted from the light guide 402 is then incident onto the display panel 10 without being attenuated, as a result of the polarizing plate 92 being removed. On the other hand, the large amount of light emitted from the light guide 401 side is attenuated by the polarizing plate 91 and it becomes similar to the amount of light emitted from the light guide 402 side. As a result, the brightness with which the segments 101 to 105 are illuminated is substantially the same.

The end surfaces 10b (FIG. 2) at the other ends of the display panel 10 are painted out in black (shaded sections). As a result, even if light reaches the end surfaces 10b of the display panel 10 due to scattering at the liquid crystal layer or because light from the LED 301 is emitted directly from the end surfaces 401c and 402c without being reflected by the end surface 401a and 402a of the light guides 401 and 402, this light is absorbed at the shaded sections 10b without being reflected. This also substantially reduces the phenomena where transparent section of the display panel 10 is made to gleam.

Electrodes 107a, 107b, 107c, 107d, 107e, 107f, 107g and 107h are provided on the lower glass 107 of the display panel 10. The electrodes 107a, 107b, 107c, 107d, 107e, 107f, 107g and 107h are electrically connected to a flexible printed board 120 via zebra gum 110 for connecting to the CPU 8 of FIG. 1. The CPU 8 controls switching over the segments 101 to 105 between transparent states and diffusing states, and controls the maintenance of a transparent state of the background of the display panel 10. Further, the two LEDs 301, together with a drive circuit (not shown in the figures) constitute the light source 30 and are electrically connected to the CPU 8 of FIG. 1 via the flexible printed board 120.

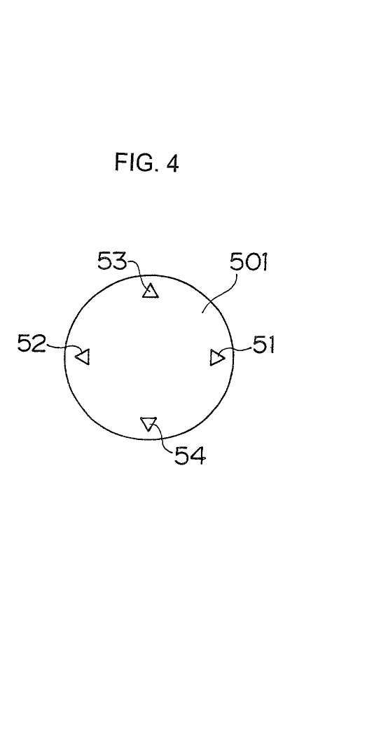

FIG. 4 is a view showing a selector 50 of an LCD illuminating device of the present invention. The selector 50 can employ, for example, a focus area selector 501 having four switches 51 to 54 to detect pushing in upward, downward, left and right directions.

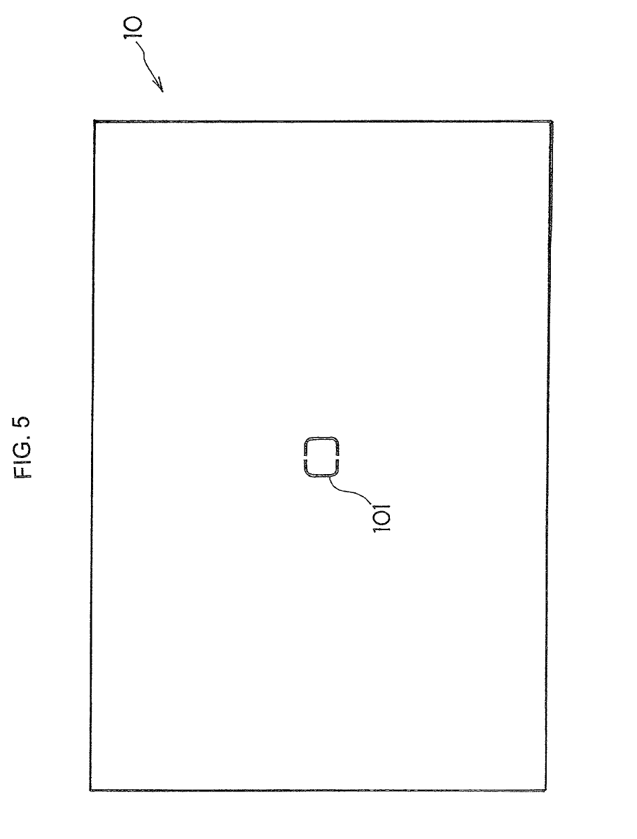

FIG. 5 is a view showing a state where a central segment 101 is selected by the focus area selector 501 shown in FIG. 4.

A description will now be given of the operation of a camera 1 equipped with an LCD illuminating device of an embodiment of the present invention shown in FIG. 1. The display panel 10 is located in the vicinity of the screen 4. An optical image formed at the screen 4 by the photographing lens 2 therefore passes through the background (background region) of the display panel 10 as it is. When a portion other than the background of the display panel 10, i.e. one of the display segments 101 to 105, is selected by the focus area selector 501 and is put into a diffusing state, light incident to this portion is diffused. This light is diffused in all directions and only a very small amount of light proceeds in the direction of a persons eye. The amount of light for the display segments that are in a diffusing state therefore falls and this segment appears dark compared to the background, i.e. the subject image and the display pattern are optically superimposed by the display panel 10.

When a sufficient amount of light does not reach the screen 4, the light source 30 lights up, and an appropriate amount of light is made to be incident onto the end surfaces 10a of the display panel 10. When light is diffused at a segment to be displayed (any one of segments 101 to 105), part of the illuminating light is diffused in the direction of the eye of an observer, and a segment to be displayed appears to be bright. This means that a display pattern is displayed brightly on a dark background in a superimposed manner.

When the luminance of the subject is sufficiently bright, the illuminating light is too dark compared with the luminance of the subject even if the light source 30 illuminates and illuminating light is incident onto the end surface 10a of the display panel 10. Therefore, rather than becoming a bright display pattern, there is a situation where a dark display pattern is superimposed on the bright subject image.

A detailed description will now be given of the operation of an LCD illuminating device of an embodiment of the present invention.

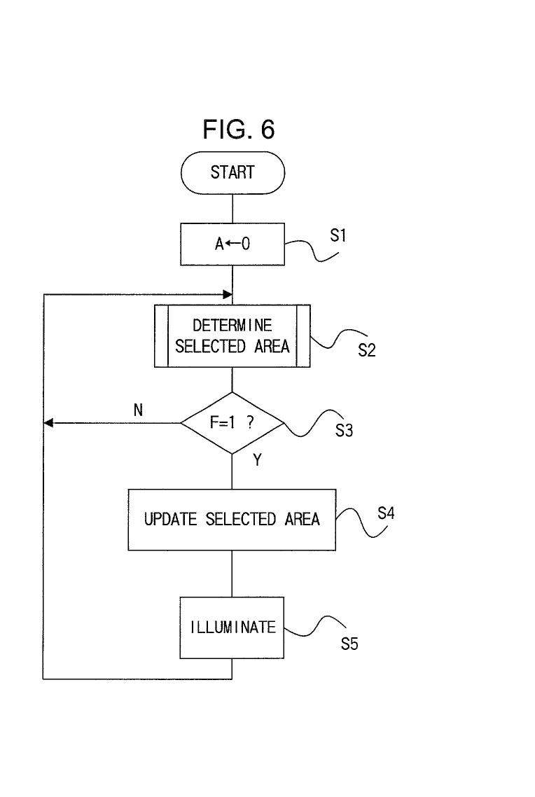

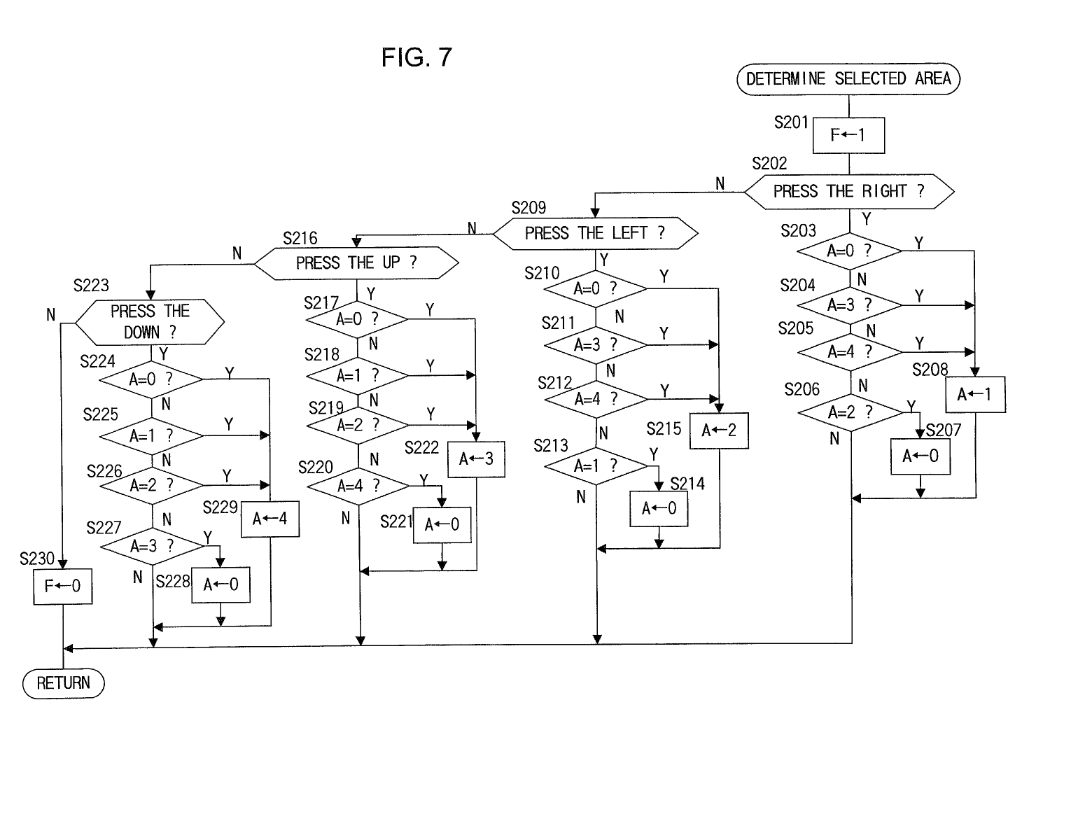

FIG. 6 and FIG. 7 are flowcharts showing operation procedures of programs executed by the CPU 8 of the LCD illuminating device of the embodiment of the present invention. When a battery is loaded, an operating program starts up, and step S1 is executed.

In step S1, the parameter A is set to 0. This parameter A displays the selected segment, with 0 showing center, 1 showing right, 2 showing left, 3 showing up, and 4 showing down. As described above, when a battery is first loaded in the camera, the drive circuit 7 inputs 0 to the parameter A so as to illuminate the central segment 101 in a diffusing state.

In step S2, a determination is made as to whether or not the focus area selector has been pressed in any of the up, down, left or right directions. The details of this are described in the following using FIG. 7.

A determination regarding the flag F is carried out in step S3. When F=0, the focus area selector 501 has not been operated, and step S2 is returned to. When F=1, the focus area selector 501 has been operated, and step S4 is proceeded to.

In step S4, an update signal is output to the drive circuit 7 in such a manner that the segment selected in step S2 is displayed in a diffusing state at the display panel 10. The drive circuit 7 receiving this update signal then outputs a signal to put a segment currently in a diffusing state on the display panel 10 into a transparent state and to put the selected segment into a diffusing state.

In step S5, two LEDs 301 are put on for just a prescribed time period (approximately 300 msec) by a circuit (not shown in the figures) for driving the light source 30, so that the segment of the display panel 10 in a diffusing state is illuminated brightly, and step S2 is returned to.

A description of the selected segment determination procedure occurring in step S2 of FIG. 6 will now be given using FIG. 7. In step S201, a flag F is set to 1. When the focus area selector 501 is not pressed in any of the up, down, left or right directions, the flag F is set to 0. This flag F shows whether or not the focus selector 501 has been operated.

In step S202 to step S208, when the switch 51 is pressed, a determination is then made as to which segments are to be put into diffusing states next depending on which segments were previously in diffusing states.

When any of the center, upper, or lower segments are currently in a diffusing state (when A is 0, 3 or 4), A is set to 1 so that the right segment is put to a diffusing state. When the left segment is currently in a diffusing state (A=2), A is set to 0 so that the center segment is put into a diffusing state. When the right segment is currently in a diffusing state (A=1), the value for the parameter A is not changed so as to maintain the diffusing state of the right segment.

In step S209 to step S215, processing to change the left side segment is carried out as with the above. In step S216 to step S222, processing to change the upper side segment is carried out as with the above. In step S223 to step S229, processing to change the lower side segment is carried out as with the above.

In step S230, when none of the switches 51 to 54 are pressed and the focus area selector 501 is not operated, the flag F is set to 0. When the above ends, step S3 of FIG. 6 is returned to.

As described above, an LCD illuminating device of a first embodiment of the present invention is equipped with light guides 401 and 402 provided at the light guide device 40 for guiding light from the LEDs 301 for providing lighting to the display panel 10. The reflecting surfaces 401a and 402a of the light guides 401 and 402 are parabolic surfaces, with the LEDs 301 being located substantially at the focal points 401b and 402b of the parabolic surfaces. Illumination of a uniform brightness is therefore possible whatever the position of segments selected for a diffusing state on the display panel 10.

### Second Embodiment

The structure of a camera equipped with an LCD illuminating device of a second embodiment is the same as for the first embodiment shown in FIG. 1. In the following, a description is mainly given of the points of distinction from the first embodiment.

In the second embodiment, the LCD illuminating device of the first embodiment is made smaller by providing reflecting surfaces at the light guides.

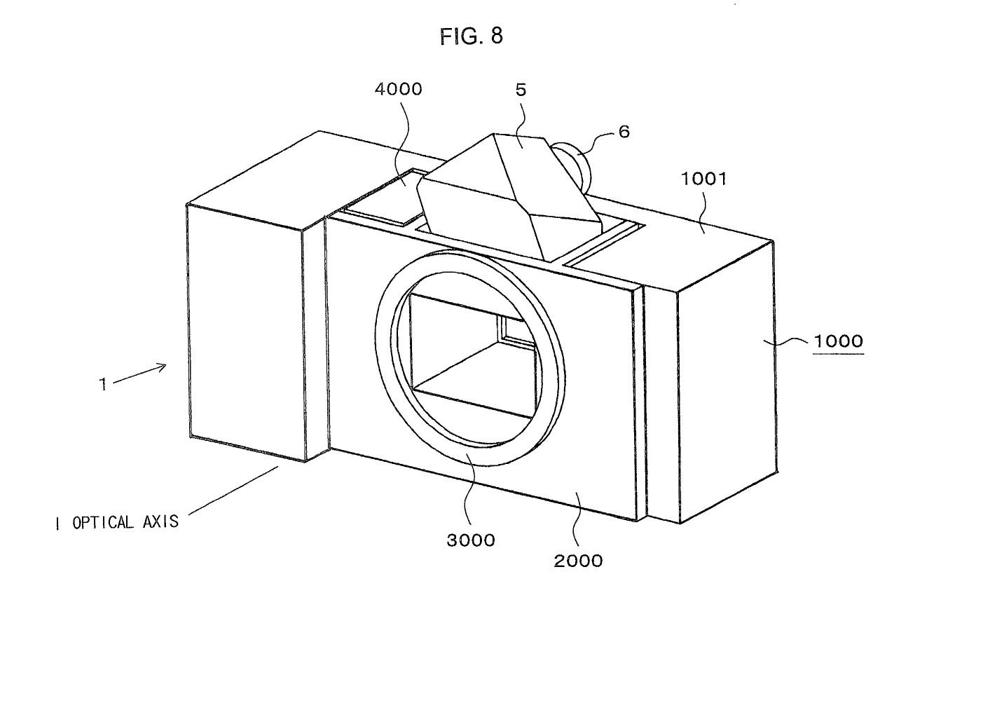

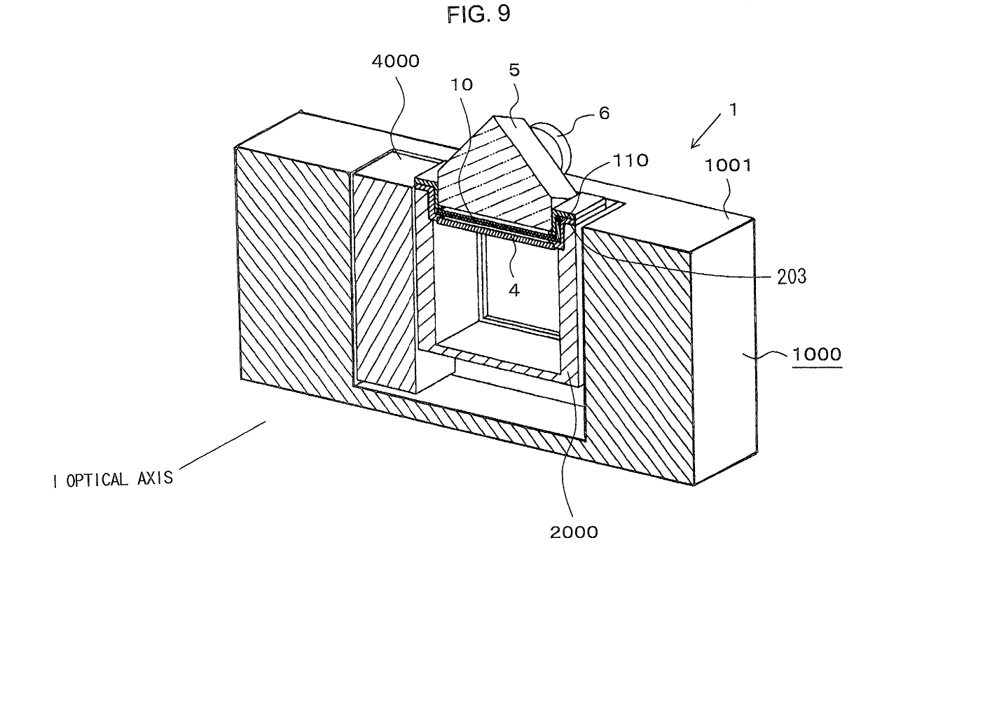

FIG. 8 is a perspective view showing the single-lens reflex camera 1 equipped with an LCD illuminating device of the second embodiment, and FIG. 9 is a perspective view cut substantially through the center of a pentaprism 5 in a plane perpendicular to an optical axis.

At the right side of the pentaprism 5, a film cartridge chamber 1001 for a film cartridge (not shown in the figures) of a back body 1000 is setup. And on the left side, a space 4000 for housing a mirror drive mechanism, and electronic substrate for an internal strobe, a capacitor, and a DC-DC converter etc. are set up.

A bayonet mount 3000 coupling with a lens mount of the photographing lens 2 and a finder unit (described later) are located at the body 2000.

A description is given of the details of a structure for an LCD illuminating device, according to the second embodiment, formed integrally with a finder unit.

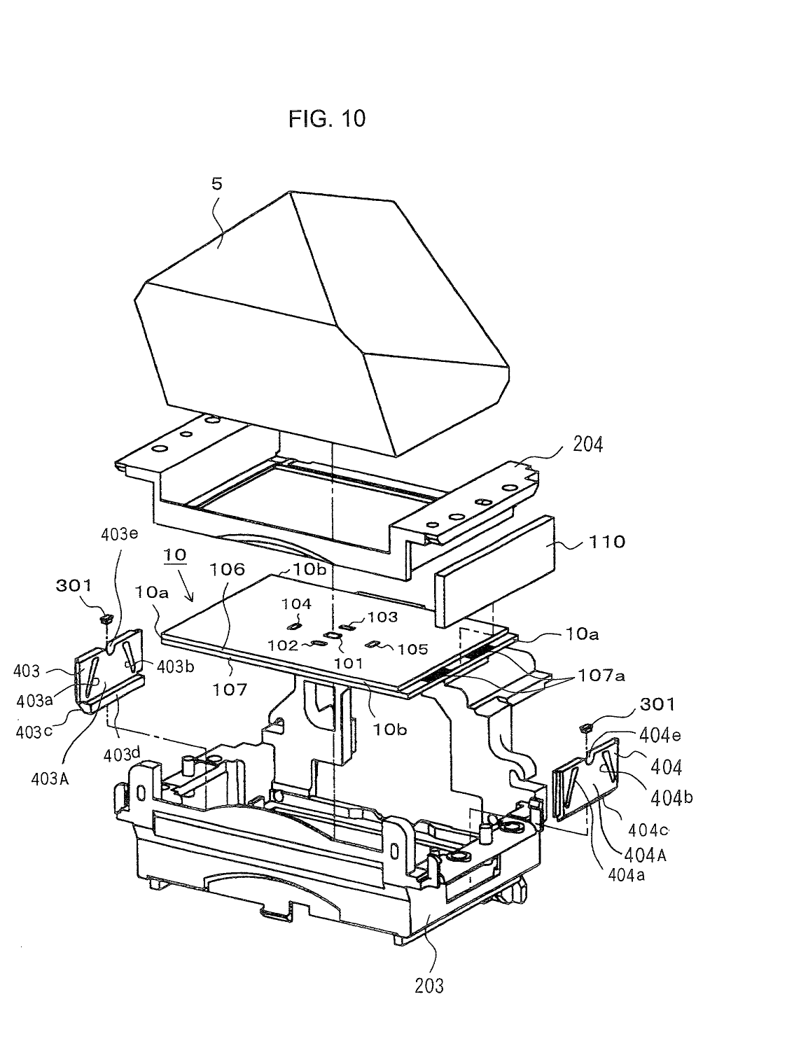

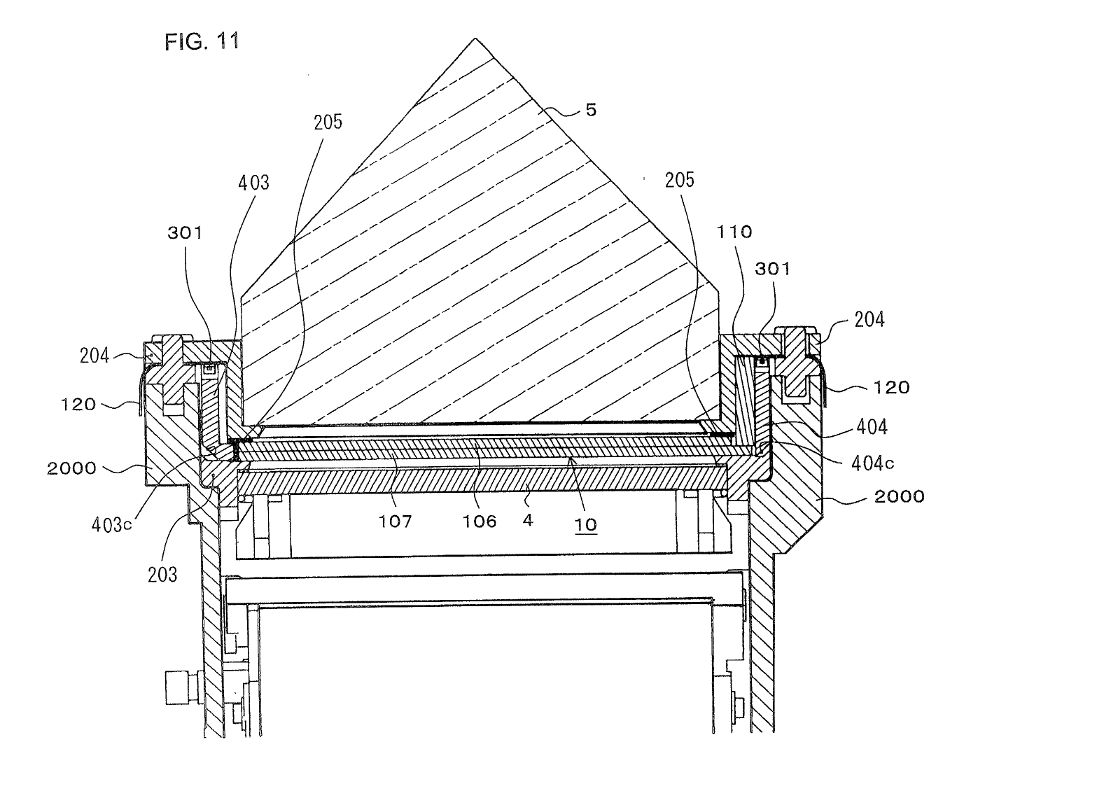

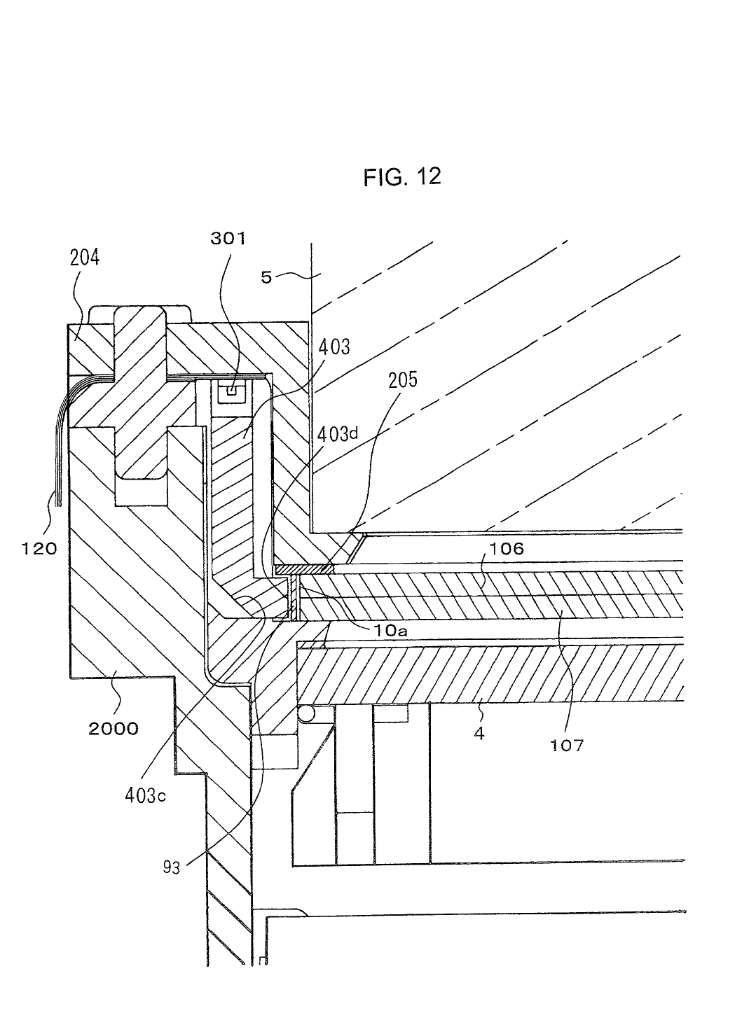

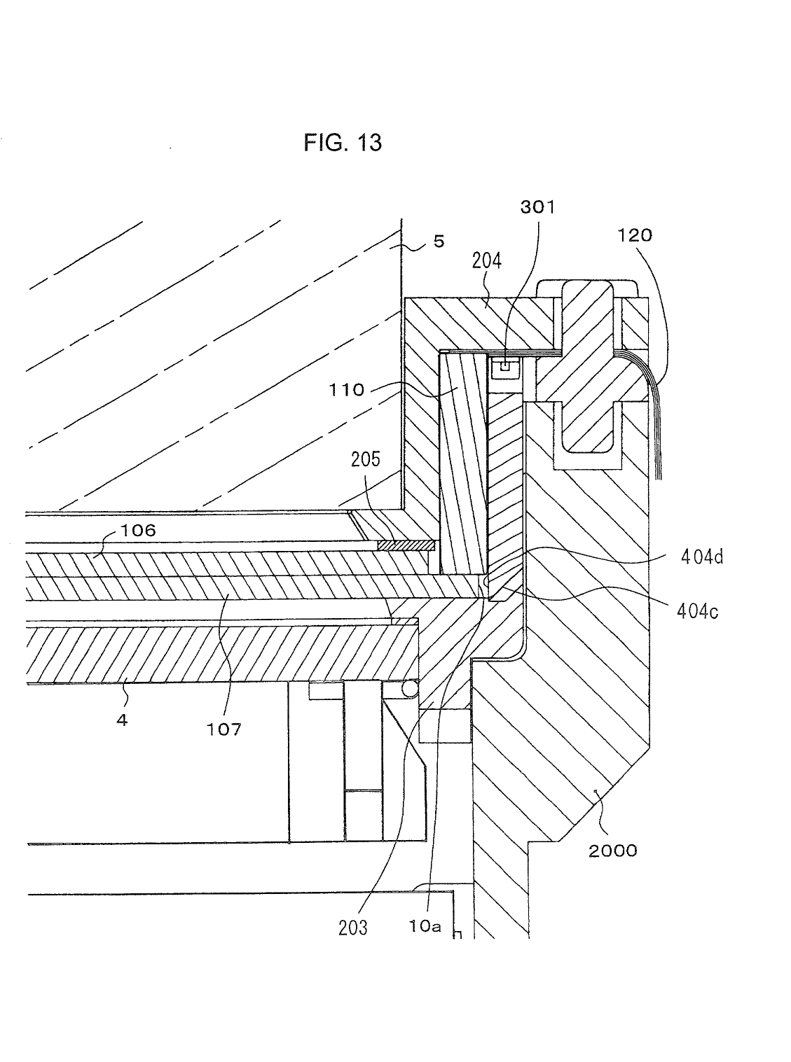

FIG. 10 is a perspective view of the light guide device 40 for guiding light from the two LEDs 301 constituting the light source 30 of FIG. 1 to end surfaces 10a of the display panel, and a support structure for the light guide device 40. FIG. 11 is a cross-sectional view cut through substantially the center of a pentaprism 5 along a plane orthogonal to an optical axis. FIG. 12 is an enlarged view of the periphery of the light guide 403 of FIG. 11, and FIG. 13 is an enlarged view of the periphery of the light guide 404 of FIG. 11. In FIG. 10 to FIG. 13, members that are the same are given the same numerals. On the display panel 10 in FIG. 10, the positions of the left segment 104 and the right segment 105 are not laterally reversed at the pentaprism 5 and will be reversed when actually viewed through the eyepiece 6.

The holder 20 shown in FIG. 1 comprises two members, a lower holder 203 and an upper holder 204 as shown in FIG. 10 and FIG. 11, and provides support by sandwiching the display panel 10. A pushing member 205 (FIG. 11) is inserted between the upper holder 204 and the display panel 10 so that the display panel 10 is reliably sandwiched and fixed between the upper and lower holders 203 and 204. The pushing member 205 consists of an elastic body made of rubber, neoprene sponge or flocked paper, etc., fixes the position of the display panel 10 in the upper and lower directions, and fixes the position of the display panel in a planar direction in such a manner as to prevent movement.

The lower holder 203 and the upper holder 204 form like a framework, with the upper holder 204 inserting into the lower holder 203.

The display panel 10 shown in FIG. 1 includes the upper and lower glass 106 and 107 (transparent substrate) parallel to the optical axis of the photographing lens 2. Liquid crystal material for display is enclosed between the upper and lower glass 106 and 107. As shown in FIG. 10, a plurality of electrodes 107a are located at an end portion of the lower glass 107 protruding from the upper glass 106. The segments 101 to 105 of the display panel 10 and the background segments are connected to these electrodes 107a. Electric power for controlling the display state of these segments is supplied from the electrodes 107a.

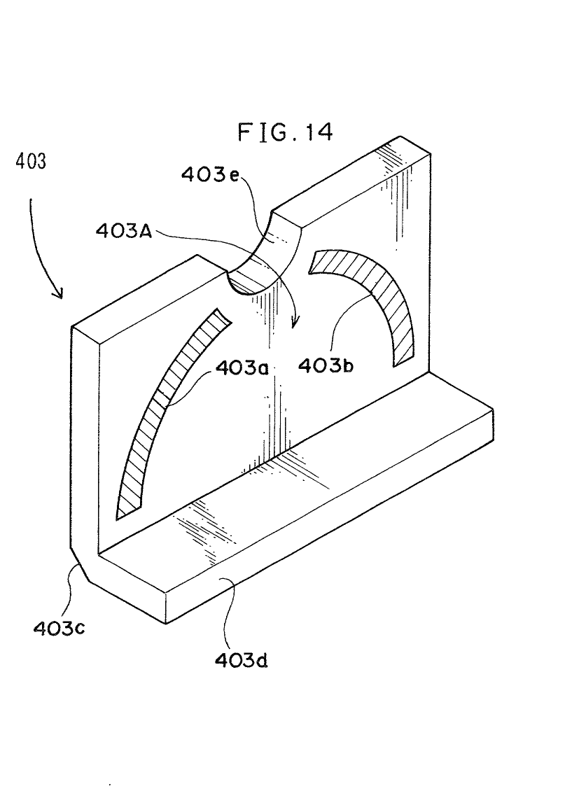

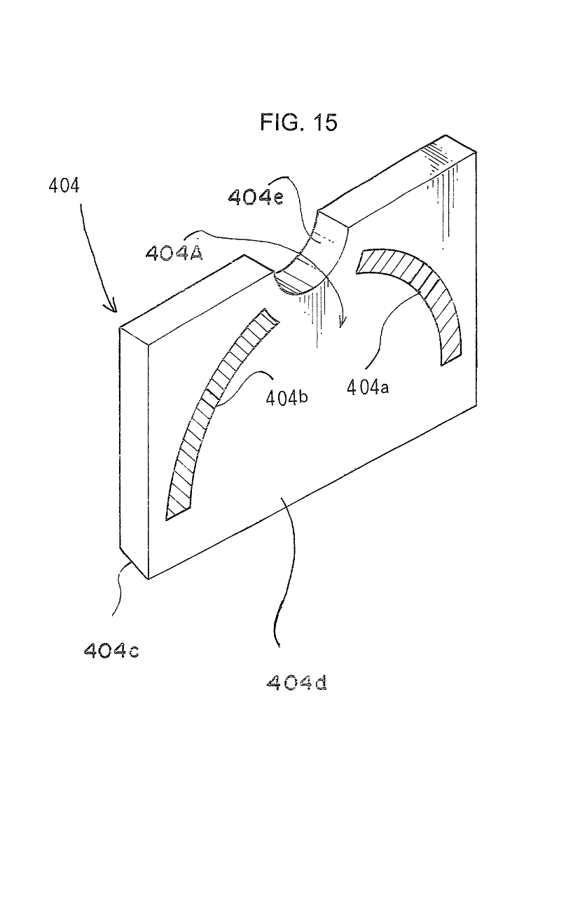

The light guide device 40 shown in FIG. 1 having two light guides (light guide members), a left light guide 403 and a right light guide 404, located in the vicinity of the end surfaces of the upper and lower glass 106 and 107. As shown in an enlarged manner in FIG. 14 and FIG. 15, these light guide 403 and 404 are equipped with light guiding sections 403A and 404A for guiding light from the light source 30 in a direction orthogonal to the display panel 10, end surfaces 403a, 403b, 404a and 404b for reflecting this light towards reflecting surfaces 403c and 404c, and the reflecting surfaces 403c and 404c for changing the direction of the light by 90 degrees to reflect the light towards emitting surfaces 403d and 404d. Light emitted from the emitting surfaces 403d and 404d of the light guides 403 and 404 is then incident onto the end surface (an irradiated part) of the upper and lower glass 106 and 107.

The light guides 403 and 404 consist of transparent polycarbonate or acrylic resin. As becomes clear from FIG. 14 and FIG. 15, channels in the shape of parabolic surfaces are formed along the light propagating in the light guiding sections 403A and 404A and form parabolic side surfaces 403a, 403b, 404a and 404b for reflecting light. It is preferable for the reflecting surfaces 403c and 404c to be made by metallizing a material of a high reflectance such as aluminum or silver etc. on inclined surfaces of the outside of the light guiding sections 403A and 404A. However, as it is easier for materials for the light guides 403 and 404 with a relatively large refractive index such as polycarbonate to achieve total internal reflect, it is not absolutely essential for the materials to be metallized on in order to take into consideration cost effectiveness.

The light guides 403 and 404 can be housed within the widthwise dimensions of the lower holder 203 by providing the reflecting surfaces 403c and 404c. When the reflecting surfaces 403c and 404c are not present, the upper side dimensions from the reflecting surfaces 403c and 404c of FIG. 11 of the light guides 403 and 404 have to be stretched out to respectively left and right of FIG. 11 (refer to FIG. 3) and protrude in the left and right directions of the lower holder 203.

As shown in FIG. 12, the thickness of the emitting surface 403d of the light guide 403 is substantially the same as the thickness of the display panel 10.

The length in the vertical direction of FIG. 13 of the emitting surface 404d of the light guide 404 is substantially the same as the length in the vertical direction of FIG. 13 of the reflecting surface 404c. A part of the upper glass 106 is cut off in order to connect the electrodes 107a of the lower glass 107 and the flexible printed board 120 using zebra gum 110. With this structure, the substantial dimension of the emitting portion of the emitting surface 404d of the light guide 404 is substantially the same as the thickness of the lower glass 107 of the display panel 10.

The light source 30 shown in FIG. 1 comprises two LEDs 301 and a circuit for driving the LEDs (not shown in the figures). The two LEDs 301 are located on the flexible printed board 120 in such a manner that the light-emitting sections of the LEDs 301 are located at focal point positions 403e and 404e of the parabolic reflecting surfaces 403a, 403b, 404a and 404b of the light guides 403 and 404 (FIG. 12 and FIG. 13).

When LED light is incident within the liquid crystal layer, some slight scattering still occurs even in the transparent sections of the liquid crystal layer. Therefore, when the LED light passes through the transparent sections of the liquid crystal layer, the transparent sections are made to gleam when the subject image is dark.

As shown in FIG. 11 and FIG. 12, a polarizing plate 93 is inserted between the end surface 10a of the display panel 10 and the light guide 403 so that it is difficult for LED light at the transparent sections of the liquid crystal layer to go out to the display surface of the display panel 10. This dramatically reduces the phenomena of the transparent sections of the display panel 10 gleaming.

The detailed description for this is the same as described for the first embodiment.

By inserting the polarizing plate 93, the amount of light from the two LEDs 301 falls, but as described above, the reflecting surfaces 403a and 403b of the light guide 403 are parabolic surfaces and the amount of light for the LEDs 301 is therefore used effectively. The reduction in the amount of light due to the introduction of the polarizing plate 93 therefore has no influence upon the brightness.

The substantial thickness of the emitting portion of the emitting surface 404d of the light guide 404 is approximately half the thickness of the emitting surface 403d of the light guide 403. A polarizing plate is not inserted between the light guide 404 and the display panel 10 because the brightness of illumination of the segments 101 to 105 is slightly influenced by the difference of the thickness. LED light outputted from the light guide 404 is therefore incident within the display panel 10 without being attenuated. On the other hand, the large amount of light emitted from the light guide 403 side is attenuated by the polarizing plate 93 and this light becomes similar to the amount of light emitted from the light guide 404 side. As a result, the brightness with which the segments 101 to 105 are illuminated is substantially the same.

Further, the end surfaces 10b (FIG. 10) at the other end of the display panel 10 are painted out in black (shaded sections). As a result, even if light reaches the end surfaces 10b of the display panel 10 due to scattering of light from the LEDs 301 at the liquid crystal layer, this light is absorbed at shaded sections 10b without being reflected. This also substantially reduces the phenomena where transparent sections of the display panel 10 is made to gleam.

The LCD illuminating device of the second embodiment configured in the above manner is formed integrally with a finder unit, is fitted into the body 2000, and is fixed using screws (not shown in the figures).

As described above, the LCD illuminating device of the second embodiment is equipped with parabolic reflecting surfaces 403a, 403b, 404a and 404b at the light guides 403 and 404 as the same manner to the first embodiment. LEDs 301 are then positioned substantially at the focal points 403e and 404e of the parabolic surfaces. The bright and uniform illumination is therefore possible whatever the position on the display panel 10 of the segment selected for a diffusing state.

The light path is bent by providing reflecting surfaces 403c and 404c for each of the light guides 403 and 404. The light guides 403 and 404 can therefore be located within the width of the lower holder 203. The light guides 403 and 404 can be incorporated as a finder unit in order to reduce size.

The present invention is by no means limited to the above embodiments and various forms and modifications are possible without deviating from the scope of the present invention.

The shape of the light guides of the LCD illuminating device according to the embodiments of the present invention is parabolic but the present invention is by no means limited in this respect. It is acceptable that at least the light within the light guides is reflected at a parabolic surface.

An example of PDLC is given as liquid crystal used in the display panel but the present invention is by no means limited in this respect. Any kind of light scattering type liquid crystal may also be adopted. For example, recently implemented polymer network type liquid crystal may also be adopted.

What is claimed is:

1. An LCD illuminating device comprising:
a display panel enclosing liquid crystal layer capable of switching between a diffusing state where light is diffused and a transparent state where light is transmitted, with a plurality of display segments;
a selection unit that selects at least one display segment of the plurality of display segments of said display panel;
a drive circuit that drives a display segment selected by said selection unit into said diffusing state and unselected display segments into said transparent state;
a light source having a light emitting section that generates light for illuminating said display panel; and
a light guide device having at least one light guide member that guides light from said light source to said display panel, wherein:
said light guide member has a reflecting surface formed at least partially in a parabolic shape, and
said light emitting section of said light source is located substantially at focal point of the parabolic reflecting surface.

2. The LCD illuminating device according to claim 1, wherein:
said display panel includes two transparent substrates;
said liquid crystal layer is enclosed between said transparent substrates, and
electrodes electrically connecting with said display segments are provided on at least one of said transparent substrates.

3. The LCD illuminating device according to claim 1, wherein:
a thickness of said light guide member is substantially the same as a thickness of said display panel.

4. The LCD illuminating device according to claim 2, wherein:
a thickness of said light guide member is substantially the same as the sum of a thicknesses of said two transparent substrates.

5. The LCD illuminating device according to claim 2, wherein:
a thickness of said light guide member is substantially the same as a thickness of one of said transparent substrates.

6. The LCD illuminating device according to claim 2, wherein:
at least two of said light guide member are provided, with a thickness of one of said light guide members being substantially the same as a thickness of one of said transparent substrates and a thickness of the other of said light guide members being substantially the same as the sum of a thicknesses of said two transparent substrates.

7. The LCD illuminating device according to claim 2, wherein:
said light guide member is located at said transparent substrates side where said electrodes are provided.

8. The LCD illuminating device according to claim 1, wherein:
shaded sections are formed respectively at end surfaces of said display panel where light is not incident.

9. An LCD illuminating device comprising:
a display panel enclosing liquid crystal layer capable of switching between a diffusing state where light is diffused and a transparent state where light is transmitted, with a plurality of display segments;
a selection unit that selects at least one display segment of the plurality of display segments of said display panel;
a drive circuit that drives a display segment selected by said selection unit into said diffusing state and unselected display segments into said transparent state;
a light source having a light emitting section that generates light for illuminating said display panel; and
a light guide device having at least one light guide member that guides light from said light source to said display panel,
wherein said light guide member is constituted by:
a light guiding section that guides light of said light source in a direction orthogonal to the display surface of said display panel;
an emitting section that emits light to an irradiated part of said display panel; and
a reflecting section that reflects light guided by said light guiding section to said emitting section.

10. The LCD illuminating device according to claim 9, wherein:
said light guide member has side surfaces along the light propagating in said light guiding section, and
said side surfaces are formed in parabolic shape respectively.

11. The LCD illuminating device according to claim 9, wherein:
dimensions of said light guide member are such that a thickness of said emitting section is substantially the same as a thickness of said display panel.

12. The LCD illuminating device according to claim 9, wherein:
said display panel is provided with electrodes at an end portion of said display panel; and
a substantial range of emission of light from said emitting section of said light guide member is restricted by a conducting member connecting said electrodes of the display panel and a circuit substrate.

13. The LCD illuminating device according to claim 9, wherein:
said display panel includes a transparent substrate parallel to an optical axis of a lens for optically forming an image, and
light emitted from said emitting section of said light guide member is incident onto said irradiated part which is located at an end surface of said transparent substrate.

14. The LCD illuminating device according to claim 9, wherein:
said display panel includes a transparent substrate parallel to an optical axis of a lens for optically forming an image, and
said light guide member is located in the vicinity of an end surface of said transparent substrate.

15. The LCD illuminating device according to claim 9, wherein:
shaded sections are formed respectively at end surfaces of said display panel where light is not incident.

16. The LCD illuminating device according to claim 10, wherein:
said light emitting section of said light source is located substantially at focal point of the parabolic reflecting surfaces.

17. The LCD illuminating device according to claim 6 further comprising:
a polarizing plate inserted between said display panel and one of said light guide members, with a thickness of which is substantially the same as the sum of a thicknesses of said two transparent substrates.

18. The LCD illuminating device according to claim 12, wherein:
a thickness of said emitting section of said light guide member is substantially the same as a thickness of said display panel,
said emitting section having no electrodes and
said LCD illuminating device further comprising:
a polarizing plate inserted between said display panel and said light guide with the thickness of said emitting section being substantially the same as the thickness of said display panel.

19. The LCD illuminating device according to claim 1 further comprising:
at least one polarizing plate inserted between said display panel and said light guide member.
